(19) United States
(12) Patent Application Publication
(10) Pub. No.: US 2024/0412735 A1
(43) Pub. Date: Dec. 12, 2024

(54) METHOD AND SYSTEM FOR PERSONALISING SPEAKER VERIFICATION MODELS

(71) Applicant: SAMSUNG ELECTRONICS CO., LTD., Suwon-si (KR)

(72) Inventors: Luca REMAGGI, Middlesex (GB); Albert Saà-Garriga, Middlesex (GB); Luther Power, Middlesex (GB); Kranthi Yanamandra, Middlesex (GB); Prashant Sharma, Middlesex (GB)

(73) Assignee: SAMSUNG ELECTRONICS CO., LTD., Suwon-si (KR)

(21) Appl. No.: 18/731,930

(22) Filed: Jun. 3, 2024

(30) Foreign Application Priority Data
Jun. 9, 2023 (GB) 2308615.0

(51) Int. Cl. G10L 17/04

(52) U.S. Cl. CPC G10L 17/04

(57) ABSTRACT

Broadly speaking, embodiments of the present techniques provide a method for personalising a trained speaker verification machine learning, ML, model for a specific user, on-device (i.e. on the end user device which is going to be used to run the personalised ML model). Advantageously, the present techniques improve the personalisation of the ML model on-device without requiring large volumes of data to be stored on the device.

### CROSS-REFERENCE TO RELATED APPLICATIONS

This application claims priority to United Kingdom Application No. GB2308615.0, filed on Jun. 9, 2023, in the United Kingdom Intellectual Property Office, which is incorporated herein by reference in its entirety.

### BACKGROUND

### Field

The present application generally relates to a method and system for personalising speaker verification models. In particular, the present application provides a method for personalising a trained speaker verification machine learning, ML, model for a specific user, on-device (i.e. on the end user device which is going to be used to run the personalised ML model).

### Description of Related Art

Voice authentication systems are increasingly used in banking. For example, unlocking devices (for making payments or otherwise), authorising payments, and other financial activities require high security and therefore, benefit from the accuracy of voice biometrics.

Currently, it is possible to improve speaker verification models (i.e. Artificial Intelligence or machine learning models that verify a speaker via their voice) by personalising the models for individual users. In this way, the models are better able to identify a specific user. The personalisation typically occurs on-device, i.e. on the user's own device. However, to perform personalisation, it is necessary to store negative samples on the device, i.e. utterances from speakers other than the user. These negative samples need to be suitably “challenging” to be useful for the personalisation process, i.e. the negative samples need to be of voices that are similar to the user's voice, so that the model can learn to distinguish between the user's voice and other similar-sounding voices. However, current technologies are unable to both identify “challenging enough” negative samples and comply with privacy laws.

It has been predicted that in 2023, 25% of employee interactions with applications will be through voice, up from 3% in 2019.

The applicant has therefore identified the need for an improved method for personalising speaker verification models.

### SUMMARY

In a first approach of the present techniques, there is provided a computer-implemented method, performed by a server, for personalising a trained speaker verification machine learning, ML, model for specific, individual users, the method comprising: obtaining at least one audio sample of the voice of the specific user; identifying, using the at least one audio sample, a group of users that have a similar voice to the voice of the specific user; selecting, from a database, a set of audio samples of voices corresponding to the identified group of users; and transmitting the selected set of audio samples to a user device used by the specific user, for personalising the trained ML model for the user using the set of audio samples.

The at least one audio sample of the voice of the specific user may also be referred to herein as enrolment data or an enrolment sample. The at least one audio sample may be collected once at setup time. For example, the specific user may take part in an enrolment process to provide at least one sample of their voice, which can then be used as a reference audio sample(s). This enrolment process may only need to be performed once per user. The audio sample(s) is preferably a sample that only contains the user's voice and no background noise.

Advantageously, the present techniques enable more accurate personalisation of speaker verification models on-device, while also reducing a memory requirement for the personalisation.

As noted above, the present techniques provide a method to personalise a speaker verification model on-device for a specific user, by obtaining a set of (negative) audio samples of voices that are similar to the user's own voice. These audio samples are referred to as “negative” samples because the voices they contain are very similar to the user's voice, but none of them belong to the user. In contrast, “positive” samples are those containing the user's voice. Generally speaking, the negative audio samples are those containing voices that have similar characteristics to the characteristics of the user's own voice. For example, the voices may have similar time-frequency components. Such time-frequency components may be formulated as features by calculating spectrograms, Mel-spectrograms, or other visual representations of the audio spectrum. The set of negative audio samples are selected from a larger set of audio samples that are stored on a central server. To select the most useful samples (i.e. the negative audio samples), the method comprises identifying a community or group of users to which the specific user belongs, using at least one audio sample of the specific user's voice. A classifier may be used to analyse the at least one audio sample to identify the community to which the specific user belongs. The community/group of users is a set of users that have similar voices or voice characteristics. The method comprises providing a set of negative audio samples to the user's device, where the negative audio samples are from the users in the community of users to which the specific user belongs. This selected set of negative audio samples is then used to train/personalise the locally-stored speaker verification ML model, so that it is better able to distinguish the user's voice from other voices that are similar to the user's.

The central server stores the (global) trained speaker verification ML model. The central server provides copies of the trained ML model to each user's client device for use on-device, and for personalisation on-device.

The trained ML model may comprise a classifier which enables the server to determine to which community/group a specific user belongs, based on the characteristics of their voice. In some cases, the classifier may be a separate ML model to the trained speaker verification ML model. The outcome of the personalisation may be used to improve the classifier on the central server. Federated learning may be used to update/improve the classifier on the central server. Thus, the step of identifying a group of users may comprise using a classifier to: process the at least one audio sample of the voice of the specific user to determine characteristics of the voice of the specific user, and to identify, based on the determined characteristics, a group of users, from a plurality of groups, that have a similar voice to the voice of the specific user. In other words, the classifier classifies the user's voice based on characteristics of the voice, and may assign a label to the user's voice. The label may be a label assigned to all the users in the group of users that have a similar voice to the user's voice.

The step of selecting a set of audio samples may comprise selecting a set of audio samples from the identified group of users which are most similar to the voice of the specific user. Thus, once the group/community of users has been identified, the method comprises selecting the best negative audio samples from all the samples within that group. That is, even within the group the user's voice may be closer to some voices within that group, and these voices form the best negative audio samples for the personalisation.

As mentioned above, it is desirable to update the classifier stored on the central server, so that the accuracy of the classifier can be improved using the training performed on-device. Thus, the method may further comprise: receiving parameters of the personalised ML models from user devices, and updating the classifier using the received parameters. That is, no user data is sent from the users to the central server (for security and privacy reasons), only parameters of their personalised ML models. For example, the parameters may be the weights of the personalised ML models. Updating the classifier may comprise aggregating parameters from the personalised trained ML model.

Updating the classifier may comprise: aggregating parameters of the personalised trained ML model received from a plurality of user devices. That is, parameters obtained from multiple user devices that have performed personalisation may be used by the server to update the classifier. The updating process may take place when parameters have been received from a certain number of user devices, for the sake of efficiency. Parameters received from user devices may be used to update the classifier of the trained ML model, such that the trained ML model is better able to distinguish between users with similar voices. This updated trained ML model may be provided to new users for personalisation on-device.

In some cases, aggregating parameters may comprise aggregating parameters received from a plurality of users in the identified group of users. That is, the parameters may be obtained from multiple client devices that are all in the same group/community. In such cases, the method may further comprise: creating a community ML model for the identified group of users based on the trained speaker verification ML model; and updating a classifier of the community ML model using the parameters received from a plurality of users in the identified group of users. That is, when parameters are received from users/user devices in the same community or group, a community version of the ML model may be created using these parameters. This community version of the ML model may then be provided to the existing users/user devices in this group as the community ML model may be better at speaker verification for this group than the original ML model, or even the individually-personalised ML model of each user/user device. The community-version of the ML model may be provided to any new user identified as belonging to this group/community. In this way, new users start their on-device personalisation using the community model rather that the more general original ML model. In cases where the classifier is separate to the ML model, a community version of the original classifier is generated instead.

In some cases, aggregating parameters may comprise aggregating parameters received from a plurality of groups of users. That is, the parameters may be obtained from multiple groups/communities. The method may further comprise: creating a community ML model for each group of users based on the trained speaker verification ML model; and updating a classifier of each community ML model using the parameters received from a plurality of users in a corresponding group of users. That is, separate community ML models may be created for each group of users. In cases where the classifier is separate to the ML model, a community version of the original classifier is generated for each group of users instead.

So far, it has been explained that once on-device personalisation has been performed, the parameters of the personalised models may be used to update the classifier and/or create community classifiers. Additionally or alternatively, information obtained from user devices when the personalised model is used to perform speaker verification may be used to update the classifier and/or create community classifiers. Thus, updating the classifier may comprise: receiving, from at least one user device, an embedding corresponding to a positively-verified audio input and a pseudo-label corresponding to the positively-verified audio input; and retraining (updating) the classifier using the received embedding and pseudo-label. That is, when the personalised ML model is used on-device to perform speaker verification for a user, for a given audio input, the ML model may determine whether the audio input contains the user's voice or not. When a user's voice is identified, the audio input is pseudo-labelled as a positive sample. (The input is “pseudo-labelled” because it is the ML model which is assigning the label). An embedding for the audio input is sent to the server alongside the pseudo-positive label. In contrast, when a user's voice is not identified, the audio input is pseudo-labelled as a negative sample. Such a negative sample is not useful for updating the classifier, so the embedding for this negative sample is not transmitted to the central server.

In a second approach of the present techniques, there is provided a central server for personalising a trained speaker verification machine learning, ML, model for specific, individual users, the server comprising: at least one processor coupled to memory, arranged for: obtaining at least one audio sample (i.e. an enrolment sample) of the voice of the specific user; identifying, using the at least one audio sample, a group of users that have a similar voice to the voice of the specific user; selecting, from a database, a set of audio samples of voices corresponding to the identified group of users; and transmitting the selected set of audio samples to a user device used by the specific user, for personalising the trained ML model for the user using the set of audio samples.

The features described above with respect to the first approach apply equally to the second approach and therefore, for the sake of conciseness, are not repeated.

In a third approach of the present techniques, there is provided a computer-implemented method, performed by a user device, for personalising a trained speaker verification machine learning, ML, model for a specific, individual user of the user device, the method comprising: obtaining and storing a trained speaker verification ML model; obtaining and storing a selected set of audio samples, the set of audio samples comprising voices that are similar to the voice of the specific user; and personalising the trained speaker verification ML model using at least one reference audio sample (i.e. an enrolment sample) comprising the voice of the specific user and the obtained selected set of audio samples. Thus, once the set of negative audio samples has been selected for a specific user, the selected samples are used to personalise the speaker verification model on the specific user's user device, so that the model can better distinguish the user's voice from other voices, particularly from other similar sounding voices.

The method may further comprise: obtaining at least one reference audio sample comprising the voice of the specific user. The at least one reference audio sample may also be referred to herein as enrolment data. The at least one reference audio sample may be collected once at setup time. For example, the specific user may take part in an enrolment process to provide at least one sample of their voice, which can then be used as the reference audio sample(s). This enrolment process may only need to be performed once per user. The reference audio sample(s) is preferably a sample that only contains the user's voice and no background noise.

Personalising the trained speaker verification ML model may comprise optimising a contrastive loss. Generally speaking, a contrastive loss is calculated when there are pairs of data items or pairs of samples to be processed by an ML model. The model may, for example, process a positive sample and a reference sample, and the contrastive loss takes the outputs of the model and calculates the distance between them. The model may also, for example, process a negative sample and a reference sample, and the contrastive loss takes the outputs of the model and calculates the distance between them. Thus, the contrastive loss may comprise: minimising a distance between the at least one audio sample and the at least one reference audio sample; and maximising a distance between the set of audio samples and the at least one reference audio sample. For the positive sample, the distance in embedding space between the positive sample and the reference sample should be small/low, meaning that the positive sample is similar to the reference sample. For the negative sample, the distance in embedding space between the negative sample and the reference sample should be large/high, meaning that the negative sample is dissimilar to the reference sample. The “distance” here may be the cosine distance between the vectors representing/encoding each sample.

The method may further comprise: sharing parameters (such as weights) of the personalised ML model with a central server. As mentioned above with respect to the first approach, sharing parameters may enable the accuracy of the classifier of the server to be improved.

In some cases, the user device is part of a group of user devices (e.g. a community defined by the similarity of the voices of the users), and the method may further comprise: sharing parameters of the personalised ML model with a second user device of the group of user devices, wherein the second user device aggregates the parameters received from user devices in the group and transmits the aggregated parameters to a central server. That is, in each group/community of users, there may be a user device which is responsible for aggregating parameters from the other user devices in the group and for transmitting these to the central server.

Alternatively, the method may further comprise: receiving ML model parameters of the personalised ML model from a plurality of user devices in the group; aggregating the received parameters; and transmitting the aggregated parameters to a central server. Thus, in this case it is this user device in the group of user devices that is responsible for aggregating parameters from the other user devices in the group and for transmitting these to the central server.

The method may further comprise: transmitting, to a central server, an embedding corresponding to a positively-verified audio input and a pseudo-label corresponding to the positively-identified audio input.

In a fourth approach of the present techniques, there is provided a user device for personalising a trained speaker verification machine learning, ML, model for a specific user, the user device comprising: at least one processor coupled to memory for: obtaining and storing a trained speaker verification ML model; obtaining and storing a selected set of audio samples, the set of audio samples comprising voices that are similar to the voice of the specific user; and personalising the trained speaker verification ML model using at least one reference audio sample comprising the voice of the specific user and the obtained selected set of audio samples.

The features described above with respect to the third approach apply equally to the fourth approach and therefore, for the sake of conciseness, are not repeated. The user device (also referred to interchangeably herein as a client device) may be a constrained-resource device, but which has the minimum hardware capabilities to use and personalise a trained neural network/ML model. The user device may be any one of: a smartphone, tablet, laptop, computer or computing device, virtual assistant device, a vehicle, an autonomous vehicle, a robot or robotic device, a robotic assistant, image capture system or device, an augmented reality system or device, a virtual reality system or device, a gaming system, an Internet of Things device, or a smart consumer device (such as a smart fridge). It will be understood that this is a non-exhaustive and non-limiting list of example user devices.

In a fifth approach of the present techniques, there is provided a computer-implemented method, performed by a user device, for performing speaker verification for a user of the user device, the method comprising: receiving a request to access a function or service which requires speaker verification; receiving an audio input containing a voice; processing, using a personalised trained speaker verification machine learning, ML, model, the received audio input; and granting access to the function or service to the user when the ML model verifies that the voice in the audio input is the voice of the user of the client device.

When the ML model verifies that the voice is the voice of the user, the method may further comprise: generating, using the ML model, an embedding and a pseudo-label for the received audio input; and transmitting, to a central server, the generated embedding and pseudo-label.

In a sixth approach of the present techniques, there is provided a system for personalising a trained speaker verification machine learning, ML, model for specific users, the system comprising: a central server comprising at least one processor coupled to memory for: obtaining at least one audio sample of the voice of each specific user of a plurality of user devices; identifying, using the at least one audio sample, a group of users that have a similar voice to the voice of each specific user; selecting, from a database, a set of audio samples of voices corresponding to the identified group of users; and transmitting the selected set of audio samples to a user device used by the specific user, for personalising the trained ML model for the user using the set of audio samples; and a plurality of user devices, each user device comprising at least one processor coupled to memory for: obtaining, from the central server, and storing the trained speaker verification ML model; receiving and storing the selected set of audio samples, the set of audio samples comprising voices that are similar to the voice of the specific user of the user device; and personalising the trained speaker verification ML model using at least one reference audio sample comprising the voice of the specific user and the obtained selected set of audio samples.

The features described above with respect to the first and third approaches apply equally to the sixth approach and therefore, for the sake of conciseness, are not repeated.

In this system, for each specific user, identifying a group of users may comprise using a classifier to: process the at least one audio sample of the voice of the specific user to determine characteristics of the voice of the specific user; and identify, based on the determined characteristics, a group of users, from a plurality of groups, that have a similar voice to the voice of the specific user.

The central server may update the classifier using parameters of the personalised ML models received from the plurality of user devices.

In a related approach of the present techniques, there is provided a computer-readable storage medium comprising instructions which, when executed by a processor, causes the processor to carry out any of the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

The method described above may be wholly or partly performed on an apparatus, i.e. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present techniques may be implemented using an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

### BRIEF DESCRIPTION OF THE DRAWINGS

Implementations of the present techniques will now be described, by way of example only, with reference to the accompanying drawings, in which:

FIG. 1 is a schematic diagram illustrating a method for personalising a trained speaker verification ML model for a specific user;

FIG. 2 is another schematic diagram of the method for personalising a trained speaker verification ML model for a specific user;

FIG. 3A is a schematic diagram showing how a classifier model G, is used to route users to the most similar community/group of users;

FIG. 3B is a schematic diagram showing how once a community has been identified for a specific user, the negative audio samples associated with that community may be selected for the specific user to personalise their SV model;

FIGS. 4A and 4B are schematic block diagrams of, respectively, a method to train a classifier, and a method to use that trained classifier to identify negative samples;

FIGS. 5A and 5B are schematic block diagrams of, respectively, a method to train a classifier, and a method to use that trained classifier to identify negative samples;

FIG. 6 is a schematic diagram illustrating how within a community k, there may be multiple users and diversity in the voices of those users;

FIG. 7 is a schematic diagram showing how the classifier may be improved by aggregating information/parameters from multiple personalised models within a community;

FIG. 8 is a schematic diagram showing how the classifier may be improved by re-labelling the training dataset used to train the classifier in the first place;

FIG. 9 is a block diagram showing steps to personalise a trained SV model for a specific user;

FIG. 10 is a table showing the results of experiments performed using existing speaker verification models;

FIG. 11 is a table showing the results of experiments performed using an existing speaker verification model that is personalised using the present techniques;

FIG. 12 is a schematic diagram showing how the contrastive loss of the present techniques works;

FIGS. 13A and 13B show results of experiments performed using an existing speaker verification model that is personalised using the present techniques;

FIG. 14 is a flowchart of example steps, performed by a server, for personalising a trained speaker verification machine learning, ML, model for a specific use;

FIG. 15 is a flowchart of example steps, performed by a client device, for personalising a trained speaker verification machine learning, ML, model for a specific use; and

FIG. 16 is a block diagram of a system 300 for personalising a trained speaker verification machine learning, ML, model for a specific user.

### DETAILED DESCRIPTION

Broadly speaking, embodiments of the present techniques provide a method for personalising a trained speaker verification machine learning, ML, model for a specific user, on-device (i.e. on the end user device which is going to be used to run the personalised ML model). Advantageously, the present techniques improve the personalisation of the ML model on-device without requiring large volumes of data to be stored on the device.

Some existing virtual assistant technologies include personalised machine learning, ML, models for speech (e.g. Speaker Verification). It is desirable to personalise ML models on-device (i.e. on the device that the ML models will be used for inference, rather than on a central server), but on-device there is currently the issue of identifying the correct set of negative samples that allow a robust training of personalization. In fact, at the moment, the same negative samples are provided to personalise the ML models for every user. This is in conflict with the concept of personalization.

Personalisation aims to “personalise” the ML model to a specific user. In a sense, this could be seen as overfitting the model to enhance the performance for that user. The present techniques may enable on-device personalisation and may be used with existing speaker verification models.

Although it is quite straight forward to collect positive samples (e.g. via users interacting with their devices using their voices), meaningful negative samples are harder to collect. This is because it is necessary, for each user, to obtain utterances that are quite similar to the user's, for robust personalisation of the model for the user. The present techniques make use of federated learning to obtain the required negative samples that are meaningful for personalising a model for a specific user.

The present techniques advantageously enable the best (i.e. most appropriate) negative samples to be found for each user, which thereby enhances the performance of the personalisation. Furthermore, this requires fewer negative samples to be stored on-device, which thereby reduces memory usage for the personalisation.

Advantageously, the present techniques mean only a small amount of training data needs to be stored on-device. Furthermore, the present techniques automatically identify the best negative samples for the personalisation process, where these negative samples are chosen for each user. Speaker verification performance is enhanced as a result of using these negative samples to perform the model personalisation. There is high data security resulting from the negative dataset being stored remotely, and the global/central ML model may be enhanced via federated learning.

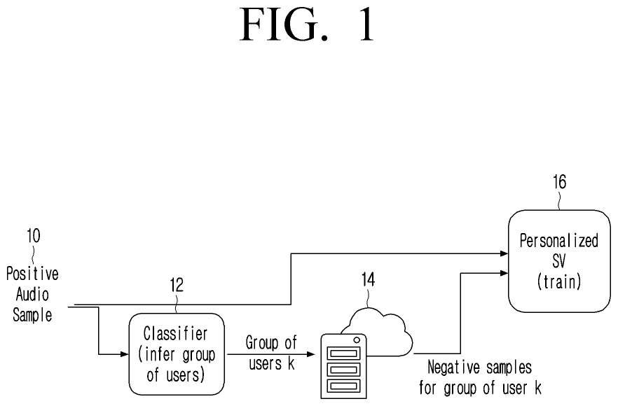

FIG. 1 is a schematic diagram illustrating a method for personalising a trained speaker verification ML model for a specific user. The present techniques provide a method to personalise a speaker verification model on-device for a specific user, by obtaining a set of (negative) audio samples of voices that are similar to the user's own voice. The set of audio samples are selected from a larger set of audio samples that are stored on a central server. To do so, the method comprises identifying a community of users to which the specific user belongs, using at least one audio sample of the specific user's voice 10. A classifier 12 may be used to analyse the at least one audio sample 10 to identify the community to which the specific user belongs. The method comprises providing a set of negative audio samples to the user's device, where the negative audio samples are selected from a database 14 of negative samples. In particular, the negative audio samples are selected from those linked to the community of users to which the specific user belongs. This selected set of negative audio samples is then used to train/personalise the locally-stored speaker verification ML model 16, so that it is better able to distinguish the user's voice from other voices that are similar to the user's. The method may also comprise updating the classifier 12, via federated learning, so that it learns from the user population.

The method may comprise three main components: selecting the set of negative audio samples and training the personalized Speaker Verification model using the selected set; identifying, using a classifier, a community of users to which the user belongs; and improving an accuracy of the classifier by aggregating data from a plurality of personalised ML models.

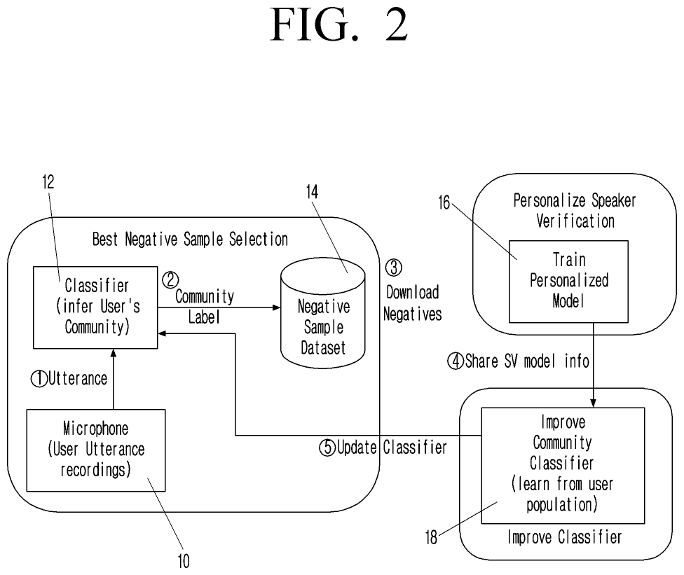

FIG. 2 is another schematic diagram of the method for personalising a trained speaker verification ML model for a specific user. FIG. 2 shows steps performed by both a central server and each client device, i.e. user device. Firstly, as mentioned above, the best negative samples need to be selected for a specific user. The best negative sample selection is performed by the central server. A database 14 of negative audio samples (which are simply audio samples containing voices of other speakers) may be divided into communities or groups. Each community or group is formed by grouping together audio samples that sound similar or have some similar audio characteristics. The best negative samples are then selected based on which group is considered to contain the best (i.e. nearest) negative samples for each user.

Utterances from the specific user (which may be obtained by the user interacting with applications on their device, such as a virtual assistant, using their voice), may be recorded and transmitted from the device to the central server. This is so that the central server can identify a group/community of users that have a similar voice to the voice of the specific user. A user may, for example, participate in an enrolment process during which a reference audio sample of their voice is recorded. This reference audio sample may then be used by the server to identify which group the user belongs to, and by the user's device during the on-device personalisation process. Once this group has been identified (indicated by the “community label” in FIG. 2), the central server can select, from database 14, a set of audio samples of voices corresponding to the identified group of users. This selected set of negative audio samples can then be transmitted to the user's device so that the trained speaker verification ML model 16 can be personalised on the user's device.

FIG. 2 shows how the method comprises personalising the speaker verification model. This may comprise training the model using the obtained selected set of audio samples. This process is performed by the specific user's client device.

FIG. 2 also shows how the method may comprise improving the classifier itself. That is, parameters from the trained/personalised SV model (e.g. pseudo-labels or model weights) may be shared within a community/group, so that a local version of the classifier (also referred to herein as the “community classifier”) may be updated. Thus, for each community, a community classifier may be updated using parameters/information obtained from the personalisation performed by the user devices within the community. The community classifier, or parameters thereof, may be periodically passed to the central server so that the central server's classifier may be updated. This enables the central classifier to be made more accurate.

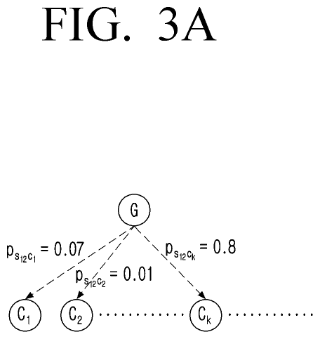

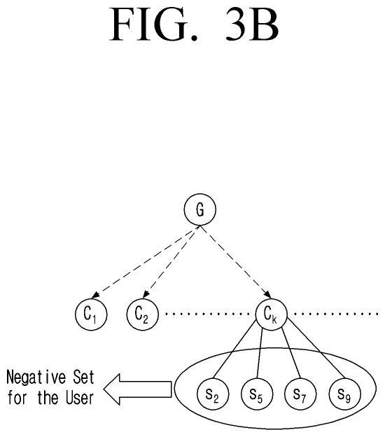

The steps to select the best negative audio samples are now described. The goal is to be able to automatically determine groups/communities of similar users. A specific user will personalise the trained SV ML model, which is obtained from the central server, using a set of negative audio samples that are most similar to the user's own audio samples. Each user is assigned to a community/group, and each user in the community/group has similarities in their voices. This means that the other users in the group are likely to provide the best negative audio samples for personalisation. FIG. 3A is a schematic diagram showing how a classifier model G, is used to route users to the most similar community/group of users.

Once a community has been identified for a specific user, the voices of other users in that community may be used to form the optimal negative dataset for speaker verification. In fact, the best negative audio samples to personalise the speaker verification model should ideally be very similar to the positive audio sample(s) (i.e. the audio samples of the specific user). This ensures that the model is trained/personalised with data that is “difficult” enough. FIG. 3B is a schematic diagram showing how once a community has been identified for a specific user, the negative audio samples associated with that community may be selected for the specific user to personalise their SV model.

In some cases, each user in each community may be a user of a specific voice-based application, such as a voice-activated virtual assistant, and this personalisation method may be implemented specifically to improve that voice-based application. By using such an application, the users may have agreed to share their speech/voice inputs with the owner of the application. This enables the users' audio samples to be obtained and used for the personalisation process, and may comply with/respect privacy policies/laws.

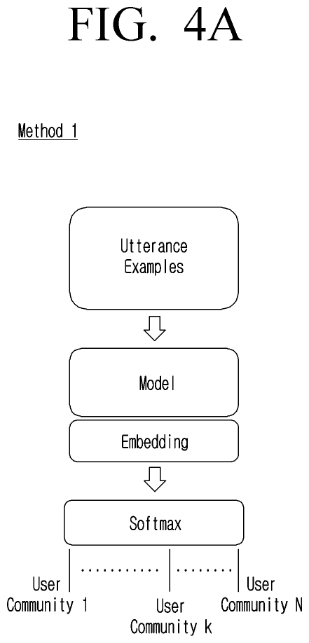

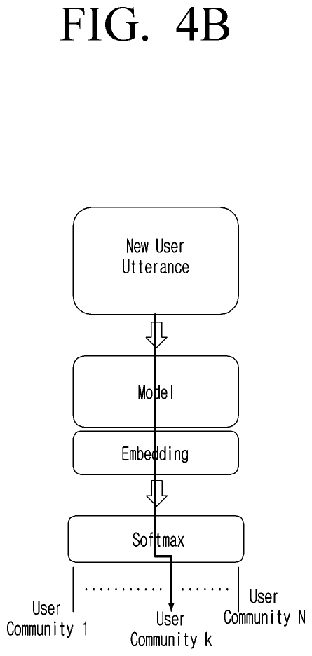

There are at least two ways to obtain the best negative samples. FIGS. 4A and 4B are schematic block diagrams of a method to train a classifier, and to use that trained classifier to identify negative samples. Here, a classifier is trained with softmax to discriminate between communities of users having similar voices. This may be advantageous when there are a fixed number of classes (i.e. groups). This may also be advantageous for languages for which there is a small volume of data (e.g. audio samples for only a few speakers) for the classifier training. FIG. 4A shows a fully-supervised training method for training the classifier, given a fixed number N of user communities/groups. FIG. 4B shows how once the classifier has been trained, it can be used to identify a community for a new user based on their audio sample. In the illustrated example, the new user is determined to belong to community k.

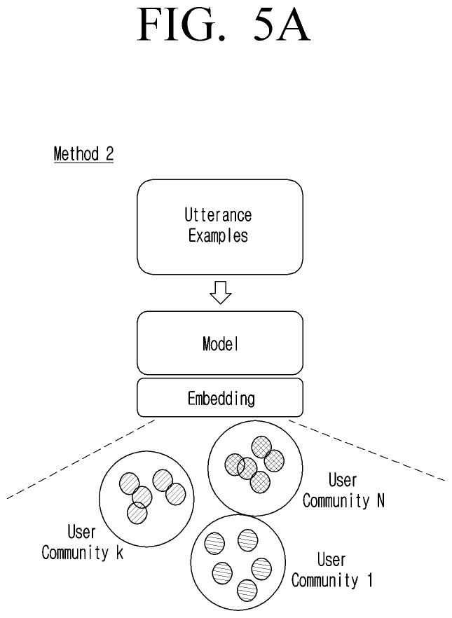

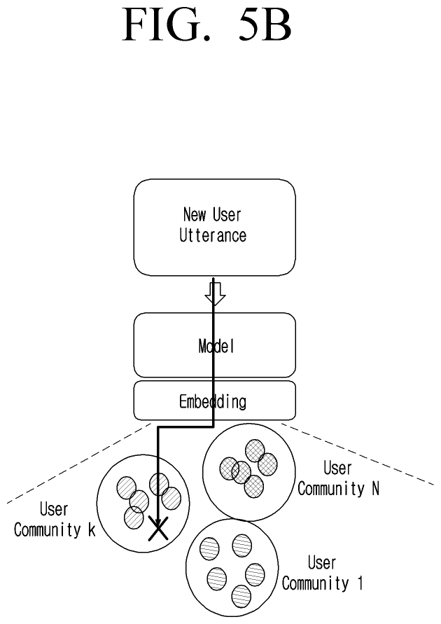

FIGS. 5A and 5B are schematic block diagrams of a method to train a classifier, and to use that trained classifier to identify negative samples. Here, a classifier is trained to perform speaker verification. The last layer in the classifier model (i.e. softmax) is then removed so that clusters can be found in embedding space. This may be advantageous when the number of classes/groups is not fixed/pre-defined. Clustering methods, such as density-based spatial clustering of applications with noise, DBSCAN, may be used to identify clusters, i.e. groups, within the data. This may also be advantageous for languages for which there is a large volume of data (e.g. audio samples for many speakers) for the classifier training. FIG. 5A shows a two-step method for training the classifier model. Firstly, the speaker verification model is trained using a supervised training method. Then, the softmax layer of the speaker verification model is removed, and the model is used to perform an unsupervised search of user communities. FIG. 5B shows how once the classifier has been trained, it can be used to identify a community for a new user based on their audio sample. In the illustrated example, the new user is determined to belong to community k.

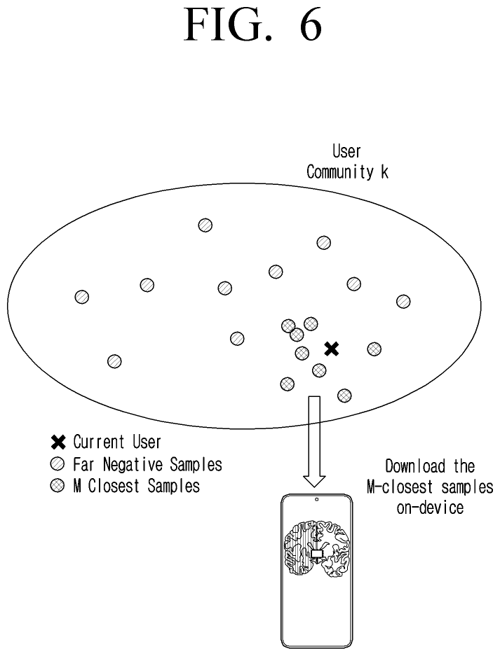

Once the most appropriate community has been identified for a user, the set of audio samples can be selected from that community. FIG. 6 is a schematic diagram illustrating how within a community k, there may be multiple users and diversity in the voices of those users. Thus, even though the users within community k are determined to have similar voices, there are still differences between the voices. Selecting a set of audio samples for a specific user may then comprise selecting a set of audio samples from the group/community which are most similar to the voice of the specific user. As shown in FIG. 6, the selected set of audio samples may be the M samples which are closest to the user's voice. Thus, in embedding space, the M number of samples from the same user community may be selected based on how close/similar they are to the user. These selected audio samples are then provided to the user device belonging to the user.

As mentioned above with reference to FIG. 2, it may be useful to update the classifier of the central server so that it learns from the user population. Thus, steps to update the classifier are now described. The updating may be performed incrementally or periodically, and may be performed using federated learning.

Information/parameters from the personalised Speaker Verification models of each user may be employed to improve a classifier of their community (i.e. the above-mentioned “community classifier”). One method to do so is by aggregating the per-user Speaker Verification models in the community, via federated learning. Another method to do so is by re-labelling the classifier dataset using pseudo-labels obtained from each community's Speaker Verification models.

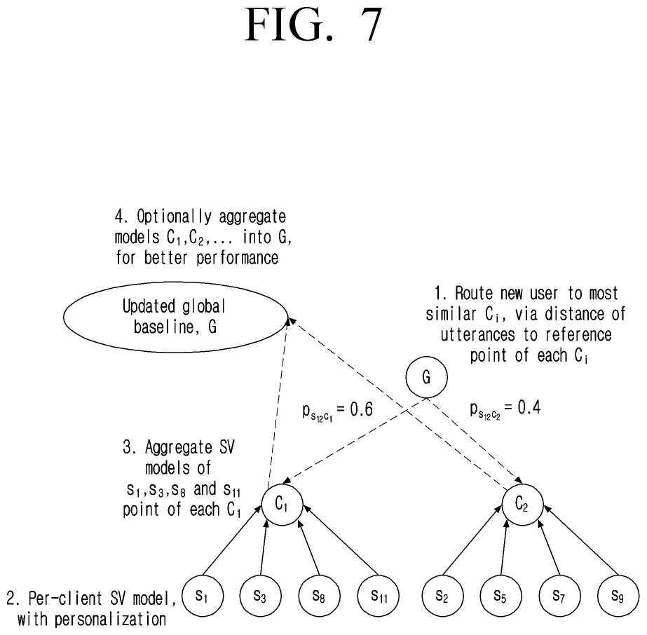

FIG. 7 is a schematic diagram showing how the classifier may be improved by aggregating information/parameters from multiple personalised models within a community. Models which have been personalised/tuned for individual users within a community enable a better understanding of that community. This method advantageously fully exploits federated learning.

As shown in FIG. 7, each user within a community has personalised their Speaker Verification (SV) model. The personalised models can be aggregated to obtain a community speaker verification model. Each community's community speaker verification model may then be aggregated to obtain a global speaker verification model. This global SV model then becomes the updated classifier, which is going to be used by the server to determine to which community a new user belongs. This method requires at least one user per-community to hold the community model in addition to their own personalised SV model.

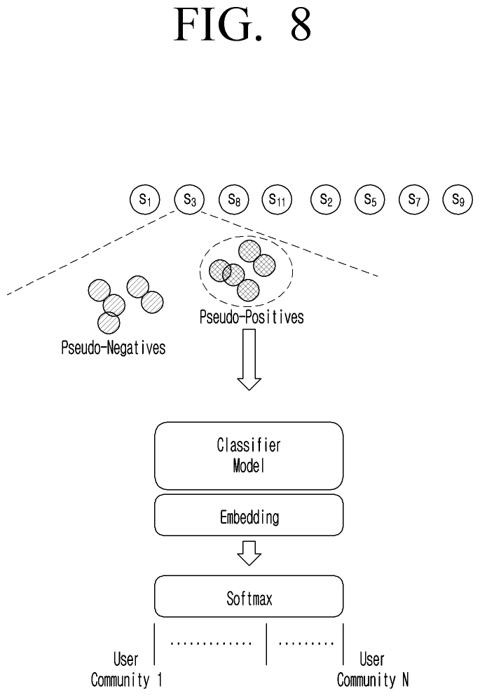

FIG. 8 is a schematic diagram showing how the classifier may be improved by re-labelling the training dataset used to train the classifier in the first place, by using pseudo-labels obtained from each community's users/models. This advantageously allows the classifier to be re-trained with more accurate data, and does not require complex model aggregations. This method may also enable potential data augmentation procedures that may further improve the classifier.

As shown in FIG. 8, each user within a community has personalised their Speaker Verification (SV) model. Each of these personalised models is going to generate pseudo-negative samples and pseudo-positive samples, when new samples are evaluated. The pseudo-positives may be sent to the community Classifier (both embeddings and labels) to update the pre-trained model with the new data.

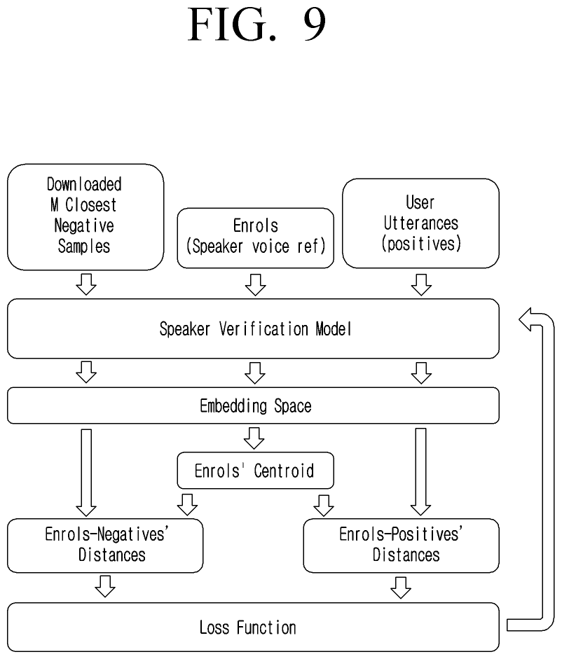

FIG. 9 is a block diagram showing steps to personalise a trained SV model for a specific user. The steps are performed by the client device belonging to the specific user. The client device first obtains a trained speaker verification ML model from the central server, and stores this locally. The client device then obtains and stores the selected set of audio samples, the set of audio samples comprising voices that are similar to the voice of the specific user. The selected set of audio samples are also obtained from the central server. The client device then personalises the trained speaker verification ML model using at least one reference audio sample comprising the voice of the specific user and the obtained selected set of audio samples.

The method performed by the client device may comprise obtaining at least one reference audio sample comprising the voice of the specific user. The at least one reference audio sample may also be referred to herein as enrolment data. The at least one reference audio sample may be collected once at setup time. For example, the specific user may take part in an enrolment process to provide at least one sample of their voice, which can then be used as the reference audio sample(s). This enrolment process may only need to be performed once per user. The reference audio sample(s) is preferably a sample that only contains the user's voice and no background noise.

As shown in FIG. 9, personalising the trained speaker verification ML model may comprise optimising a contrastive loss. The optimising may comprise: minimising a distance between the at least one audio sample comprising the voice of the user and the at least one reference audio sample (also of the user); and maximising a distance between the set of audio samples (comprising the voices of other users with similar voices) and the at least one reference audio sample (of the user).

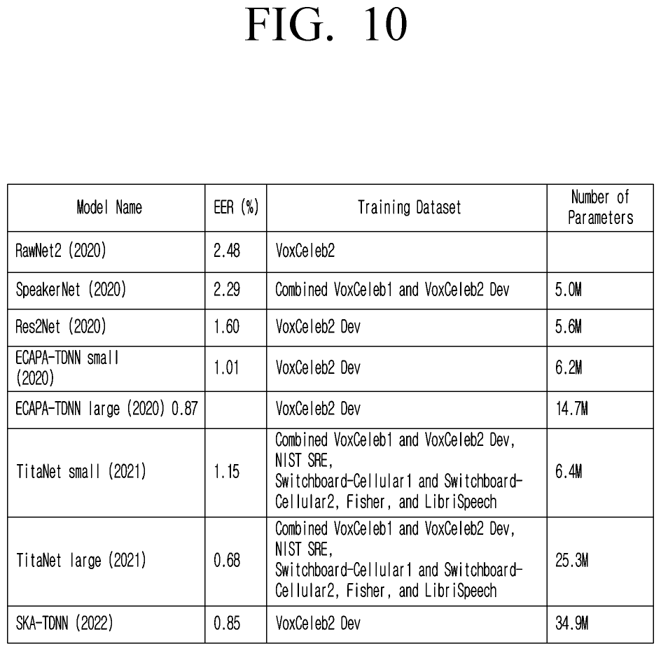

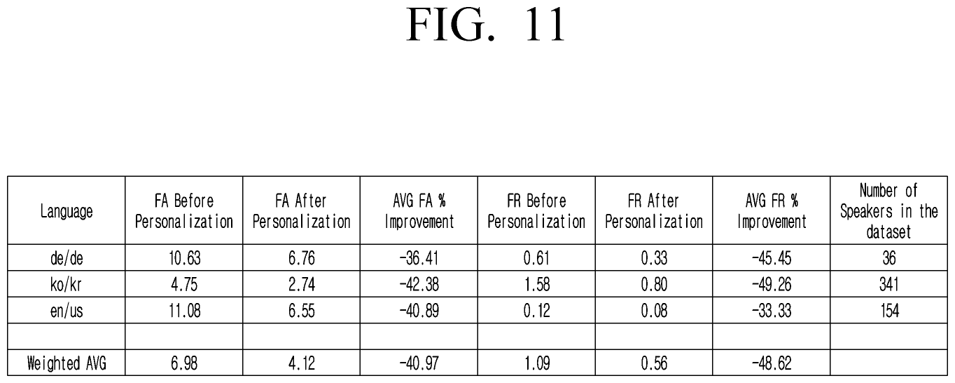

FIG. 10 is a table showing the results of experiments performed using existing speaker verification models, which form the baseline for the speaker verification experiments of FIG. 11. Each model was tested using the VoxCeleb1 dataset. Each model was measured according to equal error rate (EER), or the point where false acceptance % (security error) and false rejection % rate (user experience error) meet. The lower the better. Obviously, the larger the model (i.e. higher parameter number) the better the results. However, it is necessary to strike a balance between model performance and model size, because a too large model cannot be used on resource-constrained devices such as smartphones.

FIG. 11 is a table showing the results of experiments performed using an existing speaker verification model that is personalised using the present techniques. Personalizing models to specific users can lead to great performance improvement of any ML models that need to be run on a specific user's device. FIG. 11 shows results in terms of False Rejections (FR) and False Acceptance (FA), for a speaker verification model, before and after applying the personalization procedure. The speaker verification model used for the experiments is the latest Bixby SV model (from October 2022) and Samsung's “Hi Bixby” data. The experiments were performed for the three languages having the largest number of speakers to test with. It can be seen that as by using personalization, the FA drops from 6.98% to 4.12% and the FR drops from 1.09% to 0.56%, which means an improvement in both security (FA) and usability (FR).

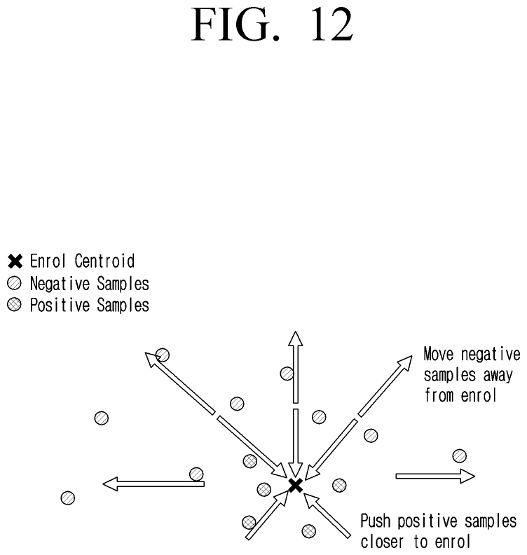

FIG. 12 is a schematic diagram showing how the contrastive loss of the present techniques works. As mentioned above, the present techniques use a contrastive loss, which means that, during the personalisation process performed on-device, positive samples are pushed as close as possible to the reference audio sample, while negative samples as pushed as far as possible from the same reference audio sample. This means that is critical to have negative samples that are as close as possible to the positive samples. In fact, when negatives are similar to the positives, because a semi-supervised learning process is used, the model is going to find the training a harder task, allowing it to find better weights, providing better results when tested (as shown in FIG. 11).

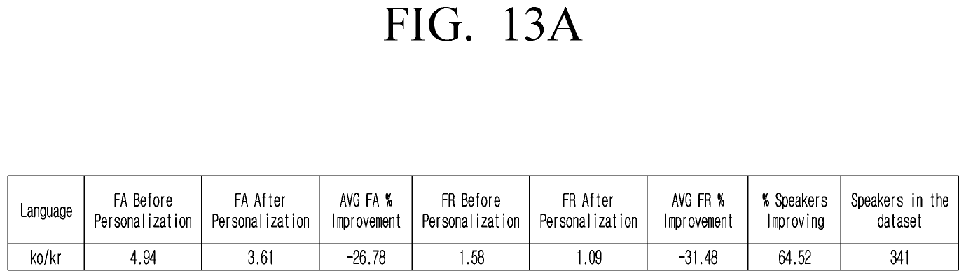

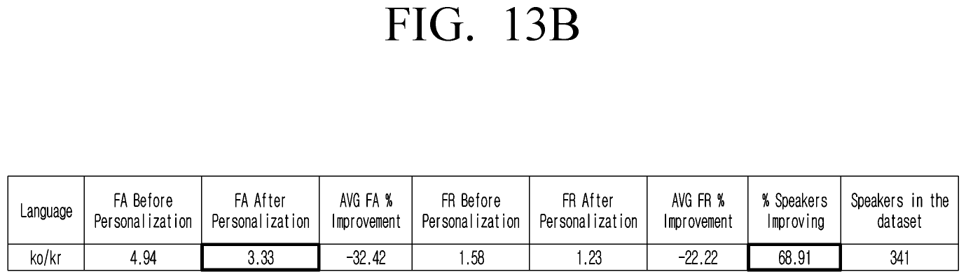

FIGS. 13A and 13B show results of experiments performed using an existing speaker verification model that is personalised using the present techniques. The experiments use two datasets. A first dataset comprises positive samples, i.e. audio samples of specific users. This dataset is used to test the personalisation. The first dataset comprised 341 individual speaker samples. A second dataset comprises negative samples. To enable on-device personalisation, a limited number of negative samples can be stored on the device, as memory/storage is limited. As already mentioned, it is necessary to choose the most relevant negative samples from the database of audio samples. Experiments where run with the Samsung “Hi Bixby” dataset, and the latest Bixby model, using ko/kr, which is the largest language dataset.

In a first experiment, for each of the 341 speaker samples in the first dataset, 25 negative samples were randomly selected from the second dataset to perform the personalisation for a specific user/voice. FIG. 13A shows the performance of the model before and after personalisation using these randomly-selected negative samples. In a second experiment, the negative samples in the second dataset were grouped into clusters (or “communities”). In the experiment, 25 clusters were formed. For each of the 341 speaker samples in the first dataset, one negative sample from each cluster of the second dataset was selected. For each user sample selected from the first dataset, the negative sample selected from each cluster was selected on the basis of it being the closest to that specific user's voice. FIG. 13B shows the performance of the model before and after personalisation using these more carefully-selected negative samples. It is clear that having a selection of carefully-selected negative samples helps the FA (False Acceptance, i.e. False Negative Rate). It can be seen that this has reduced from 3.61% (FIG. 13A) to 3.33% (FIG. 13B). This also shows that a higher number of speakers' verification is improved with personalization. In fact, the percentage of improving speaker verification increases from 64.5% to 68.91%. This proves that a method to select an optimal set of negative samples is needed as it improves the personalization results.

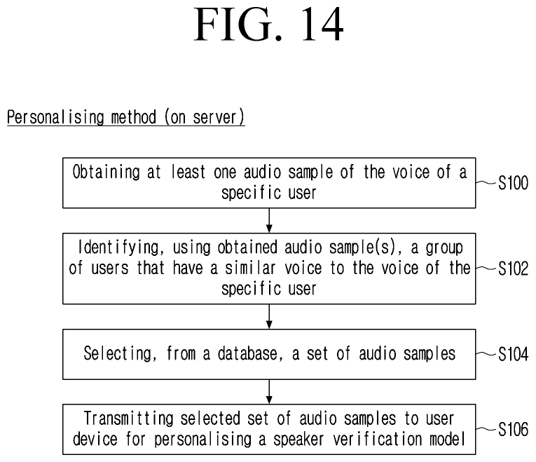

FIG. 14 is a flowchart of example steps, performed by a server, for personalising a trained speaker verification machine learning, ML, model for specific users. The method comprises comprising: obtaining at least one audio sample of the voice of a specific user (step S100); identifying, using the at least one audio sample, a group of users that have a similar voice to the voice of the specific user (step S102); selecting, from a database, a set of audio samples of voices corresponding to the identified group of users (step S104); and transmitting the selected set of audio samples to a user device used by the specific user, for personalising the trained ML model for the user using the set of audio samples (step S106).

At step S102, identifying a group of users may comprise using a classifier to: process the at least one audio sample of the voice of the specific user to determine characteristics of the voice of the specific user, and to identify, based on the determined characteristics, a group of users, from a plurality of groups, that have a similar voice to the voice of the specific user.

At step S104, selecting a set of audio samples may comprise selecting a set of audio samples from the identified group of users which are most similar to the voice of the specific user.

The method of FIG. 14 may further comprise updating the classifier using parameters of the personalised ML models received from user devices. Updating the classifier may comprise aggregating parameters of the personalised trained ML model received from a plurality of user devices. That is, parameters obtained from multiple user devices that have performed personalisation may be used by the server to update the classifier. The updating process may take place when parameters have been received from a certain number of user devices, for the sake of efficiency. Parameters received from user devices may be used to update the classifier of the trained ML model, such that the trained ML model is better able to distinguish between users with similar voices. This updated trained ML model may be provided to new users for personalisation on-device.

Aggregating parameters may comprise aggregating parameters received from a plurality of users in the identified group of users. In such cases, the method may further comprise: creating a community ML model for the identified group of users based on the trained speaker verification ML model; and updating a classifier of the community ML model using the parameters received from a plurality of users in the identified group of users. That is, when parameters are received from users/user devices in the same community or group, a community version of the ML model may be created using these parameters. This community version of the ML model may then be provided to the existing users/user devices in this group as the community ML model may be better at speaker verification for this group than the original ML model, or even the individually-personalised ML model of each user/user device. The community-version of the ML model may be provided to any new user identified as belonging to this group/community. In this way, new users start their on-device personalisation using the community model rather that the more general original ML model. In cases where the classifier is separate to the ML model, a community version of the original classifier is generated instead.

Aggregating parameters may comprise aggregating parameters received from a plurality of groups of users. The method may further comprise: creating a community ML model for each group of users based on the trained speaker verification ML model; and updating a classifier of each community ML model using the parameters received from a plurality of users in a corresponding group of users. That is, separate community ML models may be created for each group of users. In cases where the classifier is separate to the ML model, a community version of the original classifier is generated for each group of users instead. This is also described above with reference to FIG. 7.

Updating the classifier may comprise: from at least one user device, an embedding corresponding to a positively-verified audio input and a pseudo-label corresponding to the positively-verified audio input; and retraining (updating) the classifier using the received embedding and pseudo-label. This is also described with reference to FIG. 8. That is, when the personalised ML model is used on-device to perform speaker verification for a user, for a given audio input, the ML model may determine whether the audio input contains the user's voice or not. When a user's voice is identified, the audio input is pseudo-labelled as a positive sample. (The input is “pseudo-labelled” because it is the ML model which is assigning the label). An embedding for the audio input is sent to the server alongside the pseudo-positive label. In contrast, when a user's voice is not identified, the audio input is pseudo-labelled as a negative sample. Such a negative sample is not useful for updating the classifier, so the embedding for this negative sample is not transmitted to the central server.

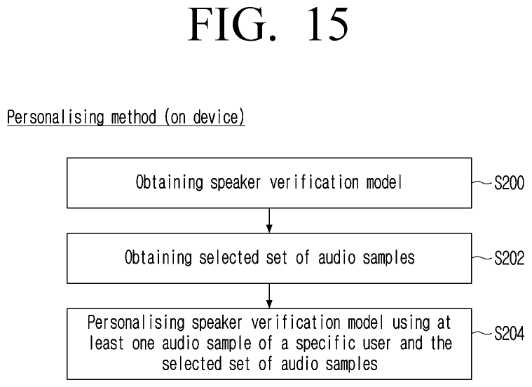

FIG. 15 is a flowchart of example steps, performed by a user device, for personalising a trained speaker verification machine learning, ML, model for a specific user of the user device. The method comprises: obtaining and storing a trained speaker verification ML model (step S200); obtaining and storing a selected set of audio samples, the set of audio samples comprising voices that are similar to the voice of the specific user (step S202); and personalising the trained speaker verification ML model using at least one reference audio sample comprising the voice of the specific user and the obtained selected set of audio samples (step S204).

The method may further comprise: obtaining at least one reference audio sample comprising the voice of the specific user.

At step S204, personalising the trained speaker verification ML model may comprise optimising a contrastive loss by: minimising a distance between the at least one audio sample and the at least one reference audio sample; and maximising a distance between the set of audio samples and the at least one reference audio sample. This is also described above with reference to FIG. 9.

The method may further comprise: sharing parameters of the personalised ML model with a central server.

The user device may be part of a group of user devices (e.g. a community defined by the similarity of the voices of the users). The method may comprise sharing parameters of the personalised ML model with a second user device of the group of user devices, wherein the second user device aggregates the parameters received from user devices in the group, and transmits the aggregated parameters to a central server. This is also described above with reference to FIG. 7.

Alternatively, the method may further comprise: receiving ML model parameters of the personalised ML model from a plurality of user in the group; aggregating the received parameters; and transmitting the aggregated parameters to a central server. This is also described above with reference to FIG. 7.

The method may further comprise: transmitting, to a central server, an embedding corresponding to a positively-verified audio input and a pseudo-label corresponding to the positively-identified audio input.

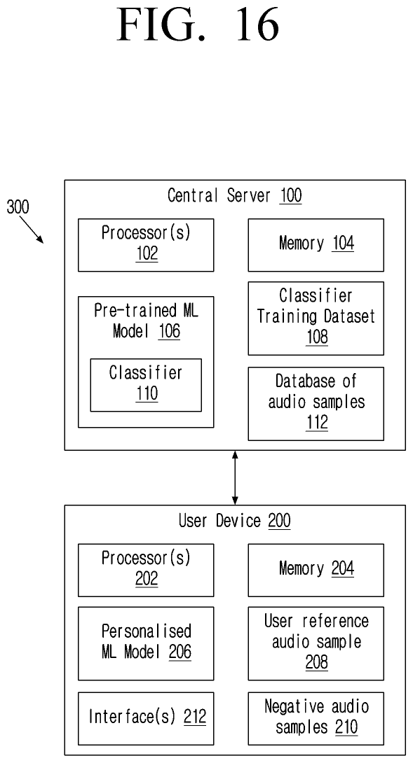

FIG. 16 is a block diagram of a system 300 for personalising a trained speaker verification machine learning, ML, model for specific users. The system 300 comprises: a central server 100 comprising at least one processor 102 coupled to memory 104 for: obtaining at least one audio sample of the voice of each specific user of a plurality of user devices 200; identifying, using the at least one audio sample, a group of users that have a similar voice to the voice of each specific user; selecting, from a database 112, a set of audio samples of voices corresponding to the identified group of users; and transmitting the selected set of audio samples to a client device used by the specific user, for personalising the trained ML model for the user using the set of audio samples.

As mentioned above, the pre-trained ML model 102 may comprise a classifier 110, and the server 100 may comprise a training dataset 108 which has been used to train the classifier 110. The classifier 110 is used to perform the identifying step.

The at least one processor 102 may comprise one or more of: a microprocessor, a microcontroller, and an integrated circuit. The memory 104 may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example.

The system 300 comprises a plurality of user devices 200. Only a single user device 200 is shown in FIG. 16 for the sake of simplicity. Each user device 200 comprising at least one processor 202 coupled to memory 204 for: obtaining, from the central server 100, and storing the trained speaker verification ML model 106; receiving and storing the selected set of audio samples 210, the set of audio samples comprising voices that are similar to the voice of the specific user of the user device; and personalising the trained speaker verification ML model (to generate personalised ML model 206) using at least one reference audio sample comprising the voice of the specific user and the obtained selected set of audio samples 210.

The user device 200 may be a constrained-resource device, but which has the minimum hardware capabilities to use and personalise a trained neural network/ML model. The user device may be any one of: a smartphone, tablet, laptop, computer or computing device, virtual assistant device, a vehicle, an autonomous vehicle, a robot or robotic device, a robotic assistant, image capture system or device, an augmented reality system or device, a virtual reality system or device, a gaming system, an Internet of Things device, or a smart consumer device (such as a smart fridge). It will be understood that this is a non-exhaustive and non-limiting list of example user devices.

The user device 200 may comprise at least one interface 212. For example, the user device 200 may comprise a microphone or audio capture device 212 for receiving utterances of the user of the user device 200. The utterances may be received during an enrolment phase to record the at least one reference audio sample, and/or when the user is controlling an application (e.g. a virtual assistant) on the user device 200 using their voice.

As mentioned above, the user device 200 may share parameters of the personalised ML model 206 with the central server 100. Sharing parameters may enable the accuracy of the classifier 110 of the server 100 to be improved.

The user device 200 may be part of a group of user devices (e.g. a community defined by the similarity of the voices of the users). In some cases, the user device may: share parameters of the personalised ML model with a second user device of the plurality of user devices in the same group, as explained above. That is, in each group/community of users, there may be a user device which is responsible for aggregating parameters from the other user devices in the group and for transmitting these to the central server.

Alternatively, the user device 200 may receive parameters from other user devices in the group, as described above. Thus, in this case it is this user device in the group of users that is responsible for aggregating parameters from the other user devices in the group and for transmitting these to the central server.

The at least one processor 202 may comprise one or more of: a microprocessor, a microcontroller, and an integrated circuit. The memory 204 may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example.

At inference time, each user device 200 may perform speaker verification for a user of the user device using the personalised ML model 206. The user device 200 may: receive a request to access a function or service which requires speaker verification; receive an audio input containing a voice; process, using the personalised trained speaker verification machine learning, ML, model, the received audio input; and grant access to the function or service to the user when the ML model verifies that the voice in the audio input is the voice of the user of the client device.

When the ML model verifies that the voice is the voice of the user, the user device may: generate, using the ML model, an embedding and a pseudo-label for the received audio input; and transmit, to the central server, the generated embedding and pseudo-label.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A computer-implemented method, performed by a server, for personalising a trained speaker verification machine learning, ML, model for specific users, the method comprising:
obtaining at least one audio sample of the voice of a specific user;
identifying, using the at least one audio sample, a group of users that have a similar voice to the voice of the specific user;
selecting, from a database, a set of audio samples of voices corresponding to the identified group of users; and
transmitting the selected set of audio samples to a user device used by the specific user, for personalising the trained ML model for the user using the set of audio samples.

2. The method as claimed in claim 1 wherein identifying a group of users comprises using a classifier to:
process the at least one audio sample of the voice of the specific user to determine characteristics of the voice of the specific user, and
identify, based on the determined characteristics of the voice of the specific user, a group of users, from a plurality of groups, that have a similar voice to the voice of the specific user.

3. The method as claimed in claim 1 wherein selecting a set of audio samples comprises selecting a set of audio samples from the identified group of users which are most similar to the voice of the specific user.

4. The method as claimed in claim 2 further comprising:
updating the classifier using parameters of the personalised ML models received from user devices.

5. The method as claimed in claim 4 wherein updating the classifier comprises:
aggregating parameters of the personalised trained ML model received from a plurality of user devices.

6. The method as claimed in claim 5 wherein aggregating parameters comprises aggregating parameters received from a plurality of user devices in the identified group of users.

7. The method as claimed in claim 6 further comprising:
creating a community ML model for the identified group of users based on the trained speaker verification ML model; and
updating a classifier of the community ML model using the parameters received from a plurality of users in the identified group of users.

8. The method as claimed in claim 5 wherein aggregating parameters comprises aggregating parameters received from a plurality of groups of users.

9. The method as claimed in claim 8 further comprising:
creating a community ML model for each group of users based on the trained speaker verification ML model; and
updating a classifier of each community ML model using the parameters received from a plurality of users in a corresponding group of users.

10. The method as claimed in claim 4 wherein updating the classifier comprises:
receiving, from at least one user device, an embedding corresponding to a positively-verified audio input and a pseudo-label corresponding to the positively-verified audio input; and
retraining the classifier using the received embedding and pseudo-label.

11. A computer-implemented method, performed by a user device, for personalising a trained speaker verification machine learning, ML, model for a specific user of the user device, the method comprising:
obtaining and storing a trained speaker verification ML model;
obtaining and storing a selected set of audio samples, the set of audio samples comprising voices that are similar to the voice of the specific user; and
personalising the trained speaker verification ML model using at least one reference audio sample comprising the voice of the specific user and the obtained selected set of audio samples.

12. The method as claimed in claim 11 wherein personalising the trained speaker verification ML model comprises optimising a contrastive loss by:
minimising a distance between the at least one audio sample and the at least one reference audio sample; and
maximising a distance between the set of audio samples and the at least one reference audio sample.

13. The method as claimed in claim 11 further comprising:
sharing parameters of the personalised ML model with a central server.

14. The method as claimed in claim 11, wherein the user device is part of a group of user devices, and the method further comprises:
sharing parameters of the personalised ML model with a second user device of the group of user devices, wherein the second user device aggregates the parameters received from user devices in the group and transmits the aggregated parameters to a central server.

15. The method as claimed in claim 11, wherein the user device is part of a group of user devices, and the method further comprises:
receiving ML model parameters of the personalised ML model from a plurality of user devices in the group;
aggregating the received parameters; and
transmitting the aggregated parameters to a central server.

16. The method as claimed in claim 11 further comprising:
transmitting, to a central server, an embedding corresponding to a positively-verified audio input and a pseudo-label corresponding to the positively-identified audio input.

17. A computer-implemented method, performed by a user device, for performing speaker verification for a user of the user device, the method comprising:
receiving a request to access a function or service which requires speaker verification;
receiving an audio input containing a voice;
processing, using a personalised trained speaker verification machine learning, ML, model, the received audio input; and
granting access to the function or service to the user when the ML model verifies that the voice in the audio input is the voice of the user of the client device.

18. The method as claimed in claim 17, wherein when the ML model verifies that the voice is the voice of the user, the method further comprises:
generating, using the ML model, an embedding and a pseudo-label for the received audio input; and
transmitting, to a central server, the generated embedding and pseudo-label.

19. A system for personalising a trained speaker verification machine learning, ML, model for specific users, the system comprising:
a central server comprising at least one processor coupled to memory for:
obtaining at least one audio sample of the voice of each specific user of a plurality of user devices;
identifying, using the at least one audio sample, a group of users that have a similar voice to the voice of each specific user;
selecting, from a database, a set of audio samples of voices corresponding to the identified group of users; and
transmitting the selected set of audio samples to a user device used by the specific user, for personalising the trained ML model for the user using the set of audio samples; and
a plurality of user devices, each user device comprising at least one processor coupled to memory for:
obtaining, from the central server, and storing the trained speaker verification ML model;
receiving and storing the selected set of audio samples, the set of audio samples comprising voices that are similar to the voice of the specific user of the user device; and
personalising the trained speaker verification ML model using at least one reference audio sample comprising the voice of the specific user and the obtained selected set of audio samples.
